(19) United States
(12) Patent Application Publication
(10) Pub. No.: US 2019/0188344 A1
(43) Pub. Date: Jun. 20, 2019

(54) LINEAR PARAMETER VARYING MODEL ESTIMATION SYSTEM, METHOD, AND PROGRAM

(71) Applicant: NEC Corporation, Minato-ku, Tokyo (JP)

(72) Inventors: Riki ETO, Tokyo (JP); Yoshio KAMEDA, Tokyo (JP)

(73) Assignee: NEC Corporation, Minato-ku, Tokyo (JP)

(21) Appl. No.: 16/311,240

(22) PCT Filed: Jun. 20, 2017
(86) PCT No.: PCT/JP2017/022712

§ 371 Date: Dec. 19, 2018

(30) Foreign Application Priority Data
Jul. 7, 2016 (JP) 2016-135115

(51) Int. Cl. G06F 17/50

(52) U.S. Cl. CPC G06F 17/5009; G06F 2217/16

(57) ABSTRACT

A linear parameter varying model estimation means (83) estimates a linear parameter varying model of a target system based on input data and output data of the target system collected under a condition around each endpoint of an operating region. When a determination is made that the prediction performance is not good, a data addition instruction means (85) outputs a message indicating an instruction for adding input data and output data of the target system collected under a condition corresponding to a point in the operating region. When the input data and the output data of the target system are additionally input, the linear parameter varying model estimation means (83) further uses the input data and the output data to estimate the linear parameter varying model.

### TECHNICAL FIELD

The present invention relates to a linear parameter varying model estimation system, a linear parameter varying model estimation method, and a linear parameter varying model estimation program that estimate a linear parameter varying model of a system.

### BACKGROUND ART

In the following description, a linear parameter varying model is referred to as an LPV model. The LPV model is a model represented by a weighted sum of a plurality of models. The plurality of models used to represent the LPV model are each referred to as a local model. FIG. 9 is a schematic diagram of the LPV model represented by the local models. An LPV model 91 is represented by a weighted sum of local models 92. A weight of each of the local models 92 is referred to as a scheduling parameter. A value of each of the scheduling parameters is equal to or greater than 0, and a sum of the values of the respective scheduling parameters of the local models 92 is 1. That is, the LPV model 91 is a convex combination of the local models 92. Further, the value of each of the scheduling parameters may vary with time, but, at any given time, the sum of the values of the respective scheduling parameters of the local models 92 is 1. Note that, although FIG. 9 illustrates four local models 92, the number of local models 92 is not limited to four.

The LPV model has an advantage of being able to represent nonlinearity and an advantage in that a linear control optimization technique is applicable to the LPV model.

In recent years, development of information collection infrastructures of physical systems such as internet of things (IoT) and machine to machine (M2M) increases importance of control of such physical systems. However, it is difficult even for experts to model a complex physical system (in other words, to estimate a model of a physical system).

A system to be modeled is referred to as a target system. Generally, in a case where the target system is modeled as an LPV model, as long as values of input data, output data, and a scheduling parameter of the target system have been obtained, the target system can be modeled.

Patent Literature 1 describes that a plant is described as an LPV model.

The LPV model is represented by the following expression (1).

$$\begin{matrix}[ Math . 1 ] & \\ \{ \begin{matrix}{x}_{k + 1} = {\sum }_{i = 1}^{m} {μ}_{k}^{( i )} ( {A}^{( i )} {x}_{k} + {B}^{( i )} {u}_{k} + {K}^{( i )} {e}_{k} ) \\ {y}_{k} = {Cx}_{k} + {Du}_{k} + {e}_{k}\end{matrix} , & ( 1 )\end{matrix}$$

In the expression (1), u is a variable representing input data to the target system, and y is a variable representing output data from the target system. Further, x is a state variable representing a state of the target system. e is a variable representing a prediction error. Further, μ is a scheduling parameter. “k” or “k+1” attached as a subscript to u, y, x, e, and μ represents a time. For example, uₖ is input data at a time k. Further, m is the number of local models, and i is a variable representing a number assigned to a local model. Numbers from 1 to m are assigned to the local models, and the local models are distinguished from each other by the numbers. It can be said that a combination of A⁽ⁱ⁾, B⁽ⁱ⁾, and K⁽ⁱ⁾ represents an i-th local model. Further, μₖ⁽ⁱ⁾ represents a scheduling parameter of the i-th local model at time k.

Once the LPV model is obtained, the use of the LPV model allows output data of the target system to be predicted.

### CITATION LIST

### Patent Literature

PTL 1: Japanese Patent Application Laid-Open No. 2012-113676

### SUMMARY OF INVENTION

### Technical Problem

A range of possible values of a condition under which the target system operates can be represented as a region. Hereinafter, this region is referred to as an operating region. FIG. 10 is an explanatory diagram illustrating an example of the operating region. Herein, a case where the target system is a drone will be described as an example. FIG. 10 illustrates an example where “wind speed” and “load weight” are given as conditions under which the drone operates, and the wind speed ranges from 0 to 5 (m/s) and the load weight ranges from 0 to 5 kg. The conditions are not limited to the wind speed and the load weight, and the operating region can be determined by focusing on conditions that a drone operator considers important.

When an LPV model of the drone is estimated, input data and output data of the drone are used. At this time, it is difficult to collect all input data and output data under each of the conditions within the range of an operating region 60. For example, it is impractical to collect all input data and output data for each combination of a value of the wind speed and a value of the load weight.

On the other hand, it is assumed that some conditions under which input data and output data are collected are determined, and the LPV model is estimated from the input data and the output data of the drone collected under each of the conditions. In this case, it is possible to predict the output data of the drone under any condition within a range surrounded by points corresponding to the plurality of conditions thus determined based on the LPV model. However, in this case, an area where prediction performance of the LPV model is not good enough may be present within the range surrounded by the points corresponding to the plurality of conditions. For example, under a condition indicated by a position away from the points corresponding to the conditions, a deterioration in the prediction performance of the LPV model or the like may occur.

In view of the above, it is an object of the present invention to provide a linear parameter varying model estimation system, a linear parameter varying model estimation method, and a linear parameter varying model estimation program capable of estimating a linear parameter varying model exhibiting good prediction performance with a less collection amount of data used for estimating the linear parameter varying model.

### Solution to Problem

A linear parameter varying model estimation system according to the present invention includes: an input means that receives information on an operating region indicating a range of possible values of a condition under which a target system to be modeled by a linear parameter varying model operates, input data and output data of the target system collected under a condition around each endpoint of the operating region, and input data and output data of the target system used for prediction performance evaluation of the linear parameter varying model; a linear parameter varying model estimation means that estimates the linear parameter varying model of the target system based on the input data and the output data of the target system collected under the condition around each endpoint; a quality determination means that determines whether prediction performance of the linear parameter varying model on output data is good based on the linear parameter varying model and the input data and the output data of the target system used for prediction performance evaluation, and designates, when determining that the prediction performance is good, the linear parameter varying model as the linear parameter varying model of the target system; and a data addition instruction means that outputs a message indicating an instruction for adding input data and output data of the target system collected under a condition corresponding to a point in the operating region when a determination is made that the prediction performance is not good. The linear parameter varying model estimation means estimates, when the input data and the output data of the target system are additionally input to the input means in response to the message, the linear parameter varying model of the target system based on the input data and the output data, and the input data and the output data of the target system collected under the condition around each endpoint.

Further, a linear parameter varying model estimation method according to the present invention includes: receiving information on an operating region indicating a range of possible values of a condition under which a target system to be modeled by a linear parameter varying model operates, input data and output data of the target system collected under a condition around each endpoint of the operating region, and input data and output data of the target system used for prediction performance evaluation of the linear parameter varying model; estimating the linear parameter varying model of the target system based on the input data and the output data of the target system collected under the condition around each endpoint; determining whether prediction performance of the linear parameter varying model on output data is good based on the linear parameter varying model and the input data and the output data of the target system used for prediction performance evaluation; designating, when determining that the prediction performance is good, the linear parameter varying model as the linear parameter varying model of the target system; outputting, when determining that the prediction performance is not good, a message indicating an instruction for adding input data and output data of the target system collected under a condition corresponding to a point in the operating region; and estimating, when the input data and the output data of the target system are additionally input in response to the message, the linear parameter varying model of the target system based on the input data and the output data, and the input data and the output data of the target system collected under the condition around each endpoint.

Further, a linear parameter varying model estimation program according to the present invention installed in a computer, the computer including an input means that receives information on an operating region indicating a range of possible values of a condition under which a target system to be modeled by a linear parameter varying model operates, input data and output data of the target system collected under a condition around each endpoint of the operating region, and input data and output data of the target system used for prediction performance evaluation of the linear parameter varying model, the program causing the computer to execute: linear parameter varying model estimation processing that estimates the linear parameter varying model of the target system based on the input data and the output data of the target system collected under the condition around each endpoint; quality determination processing that determines whether prediction performance of the linear parameter varying model on output data is good based on the linear parameter varying model and the input data and the output data of the target system used for prediction performance evaluation, and designates, when determining that the prediction performance is good, the linear parameter varying model as the linear parameter varying model of the target system; and data addition instruction processing that outputs, when a determination is made that the prediction performance is not good, a message indicating an instruction for adding input data and output data of the target system collected under a condition corresponding to a point in the operating region. The linear parameter varying model estimation processing estimates, when the input data and the output data of the target system are additionally input to the input means in response to the message, the linear parameter varying model of the target system based on the input data and the output data, and the input data and the output data of the target system collected under the condition around each endpoint.

### Advantageous Effects of Invention

According to the present invention, it is possible to estimate a linear parameter varying model exhibiting good prediction performance with a less collection amount of data used for estimating the linear parameter varying model.

### BRIEF DESCRIPTION OF DRAWINGS

FIG. 1 It depicts an explanatory diagram illustrating an example of an operating region and endpoints.

FIG. 2 It depicts a block diagram illustrating an example of a configuration of an LPV model estimation system of the present invention.

FIG. 3 It depicts a flowchart illustrating an example of a process flow of the LPV model estimation system of the present invention.

FIG. 4 It depicts a block diagram illustrating an example of a configuration of an LPV model estimation unit.

FIG. 5 It depicts a flowchart illustrating an example of a process flow of a step S2 executed by the LPV model estimation unit.

FIG. 6 It depicts a schematic diagram illustrating a newly determined operating region and endpoints of the operating region.

FIG. 7 It depicts a schematic block diagram illustrating an example of a configuration of a computer according to an exemplary embodiment of the present invention.

FIG. 8 It depicts a block diagram illustrating an outline of the linear parameter varying model estimation system of the present invention.

FIG. 9 It depicts a schematic diagram of an LPV model represented by local models.

FIG. 10 It depicts an explanatory diagram illustrating an example of the operating region.

### DESCRIPTION OF EMBODIMENT

Hereinafter, an exemplary embodiment of the present invention will be described with reference to the drawings.

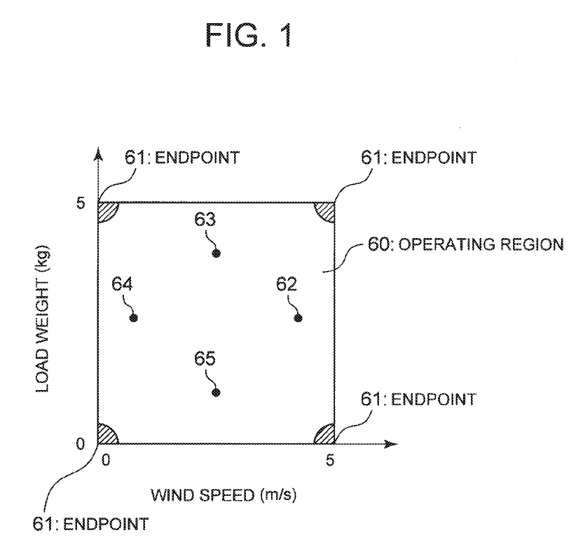

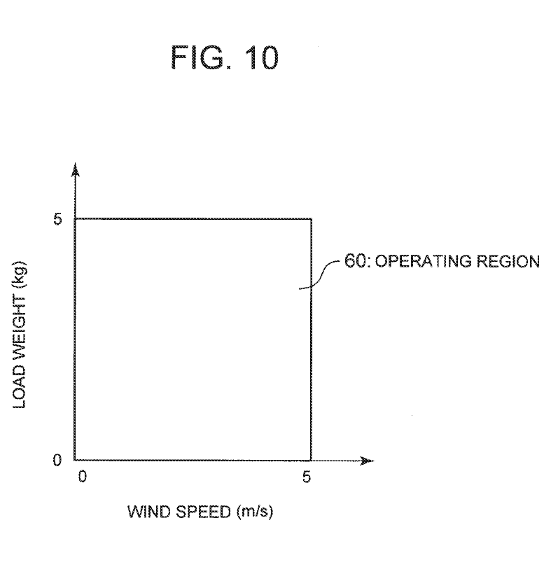

As described above, a range of possible values of a condition under which a target system operates is referred to as an operating region. Further, vertices of the operating region each correspond to a combination of an upper limit value and a lower limit value of each condition. The vertex of the operating region is referred to as endpoints. FIG. 1 is an explanatory diagram illustrating an example of the operating region and the endpoints. In the present exemplary embodiment, a description will be given of an example where the target system is a drone. In FIG. 1, as in FIG. 10, an example is illustrated where “wind speed” and “load weight” are given as conditions under which the drone operates, the wind speed ranges from 0 to 5 (m/s), and the load weight ranges from 0 to 5 kg. The conditions are not limited to the wind speed and the load weight, and the operating region can be determined by focusing on conditions that a drone operator considers important.

Each endpoint 61 corresponds to a combination of an upper limit value and a lower limit value of the two conditions of “wind speed” and “load weight (a weight of a load placed on the drone)”.

Further, as the upper limit value and the lower limit value of each of the conditions, for example, an upper limit value and a lower limit value specified in a specification of the target system (the drone in the present exemplary embodiment) may be used. For example, when, in the specification of the drone, the upper limit value and the lower limit value of the wind speed at which the drone is allowed to operate are specified as “5 m/s” and “0 m/s”, respectively, an operating region 60 may be determined such that the upper limit value and the lower limit value of the wind speed are equal to “5 m/s” and “0 m/s”, respectively. The same applies to the upper limit value and the lower limit value of the load weight. In this case, it can be said that the endpoints 61 are determined based on the specification of the target system.

Note that, for the sake of simple description, the present exemplary embodiment will be described with reference to an example where the number of the conditions is two and the operating region is represented in two dimensions. However, the operating region may be determined by three or more conditions. Further, the operating region may be determined by one condition. In a case where the operating region is determined by one condition, the operating region is represented by a line segment.

A linear parameter varying model estimation system of the present invention (hereinafter, referred to as an LPV model estimation system) first estimates an LPV model based on input data and output data of the target system collected under conditions around each of the endpoints 61. Each of the endpoints 61 corresponds to one local model.

To be more specific, the conditions around the endpoint 61 correspond to any conditions that lie around the endpoint 61 and within a range of the operating region 60. For example, in the example illustrated in FIG. 1, any conditions within hatched ranges correspond to the conditions around the endpoint 61.

Further, in the LPV model estimated by the LPV model estimation system of the present invention, a scheduling parameter is represented by a function using an explanatory variable. The function representing the scheduling parameter using the explanatory variable is referred to as a scheduling parameter prediction model.

Further, a value of the scheduling parameter of each local model may vary with time. An explanatory variable at a time k is represented by φₖ. Further, a scheduling parameter of an i-th local model at time k is represented by μₖ⁽ⁱ⁾. Furthermore, a scheduling parameter prediction model of the i-th local model at time k is represented by the following expression (2).

[Math. 2]

μₖ⁽ⁱ⁾=gᵢ(ϕₖ) (2)

In the present invention, the LPV model is represented by the following expression (3).

$$\begin{matrix}[ Math . 3 ] & \\ \{ \begin{matrix}{x}_{k + 1} = {\sum }_{i = 1}^{m} {g}_{i} ( {φ}_{k} ) ( {A}^{( i )} {x}_{k} + {B}^{( i )} {u}_{k} + {K}^{( i )} {e}_{k} ) \\ {y}_{k} = {Cx}_{k} + {Du}_{k} + {e}_{k}\end{matrix} , & ( 3 )\end{matrix}$$

In the expression (3), the scheduling parameter μₖ⁽ⁱ⁾ in the above-described expression (1) is represented by a scheduling parameter prediction model gᵢ(φₖ), and the meaning of each of the other variables in the expression (3) is the same as the meaning of a corresponding variable in the expression (1).

Generally, as long as values of the input data, the output data, and the scheduling parameter of the target system have been obtained, the LPV model of the target system can be estimated. The LPV model estimation system of the present invention is capable of estimating the LPV model even if the value of the scheduling parameter is not obtained.

As described above, the LPV model estimation system of the present invention first estimates the LPV model based on the input data and the output data of the target system collected under the conditions around each of the endpoints 61. The LPV model is represented by the expression (3). Adjusting the value of the explanatory variable in the expression (3) allows the output data to be predicted under conditions corresponding to any point in the operating region 60. When the value of the explanatory variable is determined, the value of the scheduling parameter of each local model is determined, and as a result, one point in the operating region 60 is determined. Accordingly, the output data can be predicted under the conditions corresponding to that point. Therefore, adjusting the value of the explanatory variable of the scheduling parameter prediction model to one point in the operating region 60 representing desired conditions allows the output data to be predicted under the desired conditions.

Then, when a determination is made that the prediction performance of the LPV model is not good, input data and output data of the target system are additionally input to the LPV model estimation system, and the LPV model estimation system re-estimates the LPV model from the input data and the output data.

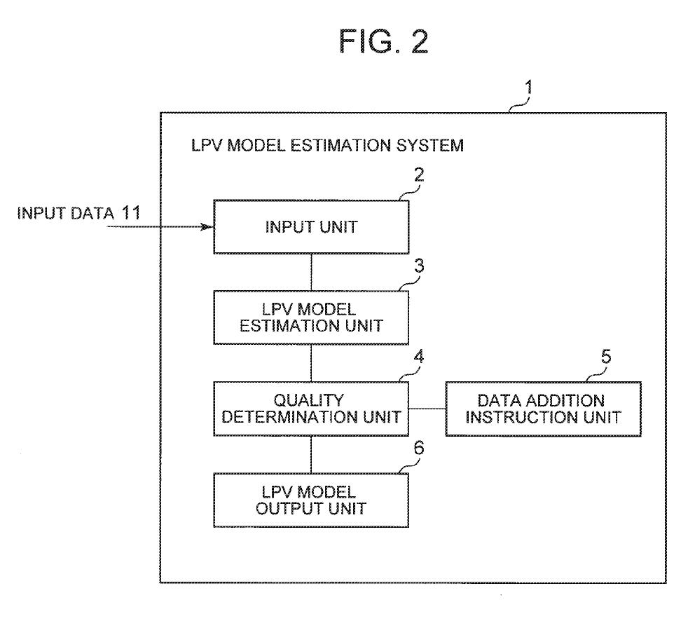

FIG. 2 is a block diagram illustrating an example of a configuration of the LPV model estimation system of the present invention. An LPV model estimation system 1 of the present invention includes an input unit 2, an LPV model estimation unit 3, a quality determination unit 4, a data addition instruction unit 5, and an LPV model output unit 6.

The input unit 2 is an input device for inputting input data 11. The input data 11 is data used for the LPV model estimation system 1 to estimate the LPV model of the target system (target system to be modeled). The input unit 2 is, for example, a data reading device that reads the input data 11 stored in a data recording medium such as an optical disk, but the input unit 2 is not limited to such a data reading device. The input unit 2 may be an input device for a user of the LPV model estimation system 1 to input the input data 11.

Hereinafter, information included in the input data 11 will be described.

The input data 11 includes information on the operating region 60. For example, the input data 11 includes coordinates of each of the endpoints 61 as information for defining the operating region 60.

Further, the input data 11 includes input data and output data of the target system collected by the operator of the drone (the target system) under the conditions around each of the endpoints 61. Note that the reference numeral 11 is attached to the input data input to the LPV model estimation system 1 of the present invention and no reference numeral is attached to the input data input to the target system to distinguish between the two pieces of input data. As described above, to be more specific, the conditions around the endpoint 61 correspond to any conditions that lie around the endpoint 61 and within the range of the operating region 60.

Here, the time is represented by k. The drone operator collects values of the input data to and values of the output from the drone at times k=1, 2, . . . , N under the conditions around each of the endpoints 61. N is, for example, 1000, but is not limited to 1000. Such values of the input data and values of the output data at each of the times under the conditions are included in the input data 11. Note that the time is represented by 1, 2, 3, . . . , N in order from the earliest time.

The input data 11 further includes input data and output data of a drone used for prediction performance evaluation of the LPV model. The drone operator collects, for example, values of input data to and values of output data from the drone at times k=1, 2, . . . , M under conditions corresponding to points 62 to 65 (see FIG. 1) away from each of the endpoints 61. M is, for example, 100, but is not limited to 100. The input data and the output data thus collected are included in the input data 11 as data used for prediction performance evaluation. Here, the conditions corresponding to the points 62 to 65 (see FIG. 1) have been given as examples of the conditions for the collection of the data used for prediction performance evaluation, but the conditions for the collection of the data used for prediction performance evaluation need not to be limited to the conditions corresponding to the points 62 to 65. For example, the number of points corresponding to the conditions for the collection of the data used for prediction performance evaluation needs not to be limited to four. Further, for example, the conditions for the collection of the data used for prediction performance evaluation may be conditions corresponding to one point.

When the drone operator collects the input data and the output data, conditions such as wind speed need not to be strictly kept constant.

Further, the drone operator may collect the input data and the output data of the drone with a facility capable of setting the condition such as the wind speed to a desired value.

Further, the description has been given of the case where the drone operator collects the values of the input data and the values of the output data of the drone at times k=1, 2, . . . . The operator may cause a plurality of drones to fly simultaneously under different conditions and collect values of input data and values of output data of each of the drones at each time.

Alternatively, the operator may cause one drone to fly under certain conditions and collect values of input data and values of output data at a plurality of consecutive times, and then cause the drone to fly under different conditions and collect values of the input data and values of the output data at the plurality of consecutive times to collect input data and output data under various conditions. In this case, the data collection time differs for each condition, but times k=1, 2, . . . may be assigned, for the sake of convenience, as consecutive times when data is collected under various conditions.

Note that examples of the input data of the drone include a rotation speed of a rotor of the drone. Further, examples of the output data of the drone include an attitude and position of the drone.

The input data 11 further includes the number of local models. Hereinafter, the number of local models is assumed to be m. Since each of the endpoints 61 corresponds to one local model, the number of endpoints 61 (four in the example illustrated in FIG. 1) may be used as the number of local models.

The input data 11 further includes a value of a window parameter in the subspace identification scheme. Hereinafter, the value of the window parameter is represented by p. In the subspace identification scheme, a set of pieces of data (time series data) arranged consecutively in time order is handled as sample data. Hereinafter, this sample data will be referred to as a time series sample. One time series sample is a vector in which p pieces of data are arranged in time order. Further, p<N is satisfied. Further, a time series sample in which p pieces of data are arranged in order where a piece of data at the time k is a first piece of data is referred to as a time series sample at time k. It can be said that the time series sample represents a temporal change in data. When N pieces of data are given, N−p+1 time series samples are obtained from the N pieces of data. In the subspace identification scheme, the mapping relation between time series samples is used.

The input data 11 further includes information indicating a format of the scheduling parameter prediction model determined for each of the m local models. For example, when the scheduling parameters of the first and second local models are μ⁽¹⁾ and μ⁽²⁾, the input data 11 includes information indicating that the scheduling parameters of these local models are represented by μ⁽¹⁾=a×φ+b, μ⁽²⁾=c×φ²+d×φ, and the like. In the above-described example, φ is an explanatory variable, a, c, and d are coefficients, and b is a constant term. This information merely indicates a function format, and does not define values of the coefficients a, c, d, and the like, and a value of the constant term b given as examples. In the above-described example, the function formats of the two local models have been given, but a function format is determined for each of the m local models. Further, the above-described two function formats are examples, and the function format is not limited to the above-described examples. Each of the functions (scheduling parameter prediction models) is derived as a regression model as described later.

The input data 11 further includes values of the explanatory variable φ at times 1 to N.

The LPV model estimation unit 3 estimates the LPV model of the drone based on the input data and the output data of the drone collected under the conditions around each of the endpoints 61.

Further, after the LPV model estimation unit 3 estimates the LPV model, the drone operator may collect input data and output data of the drone under conditions corresponding to a point in the operating region 60 and additionally input the input data and the output data to the input unit 2. In this case, the LPV model estimation unit 3 re-estimates the LPV model of the drone based on the input data and the output data of the drone collected under the conditions around each of the endpoints 61 and the input data and the output data of the drone newly collected and additionally input to the input unit 2 by the operator.

The LPV model estimation unit 3 estimates the LPV model represented by the expression (3). That is, the LPV model estimation unit 3 estimates the LPV model in which the scheduling parameter is represented by the scheduling parameter prediction model. In other words, the LPV model estimation unit 3 represents, in the LPV model, the scheduling parameter as the scheduling parameter prediction model.

Details of an example of a configuration of the LPV model estimation unit 3 and details of a process flow of the LPV model estimation unit 3 that estimates the LPV model will be described later.

The quality determination unit 4 determines, based on the LPV model estimated by the LPV model estimation unit 3 and the input data and output data of the drone used for prediction performance evaluation of the LPV model, whether prediction performance of the LPV model estimated on output data of the drone is good. The quality determination unit 4 may calculate a predicted value of the output data of the drone at the time subsequent to each time from the input data and the output data of the drone used for prediction performance evaluation and the LPV model estimated and determine, based on a difference between the predicted value and the value of actual output data, whether the prediction performance of the LPV model estimated on output data is good.

When determining that the prediction performance of the LPV model estimated on output data is good, the quality determination unit 4 designates (in other words, confirms) the LPV model as the LPV model of the drone.

The LPV model output unit 6 outputs the LPV model confirmed as the LPV model of the drone. For example, the LPV model output unit 6 may cause a display device (not illustrated in FIG. 2) included in the LPV model estimation system 1 to display the LPV model. However, no particular limitation is imposed on the mode in which the LPV model output unit 6 outputs the LPV model confirmed.

When the quality determination unit 4 determines that the prediction performance of the LPV model on output data is not good, the data addition instruction unit 5 outputs a message indicating an instruction for adding input data and output of the drone collected under conditions corresponding to a point in the operating region 60. For example, the data addition instruction unit 5 may cause the display device (not illustrated in FIG. 2) included in the LPV model estimation system 1 to display this message. No particular limitation is imposed on the mode in which the message is output.

When the above-described message is output, the drone operator collects the input data and the output data of the drone under the conditions corresponding to the point in the operating region 60 in response to the message. When the input data and the output data are additionally input to the input unit 2, as described above, the LPV model estimation unit 3 re-estimates the LPV model also from the input data and the output data.

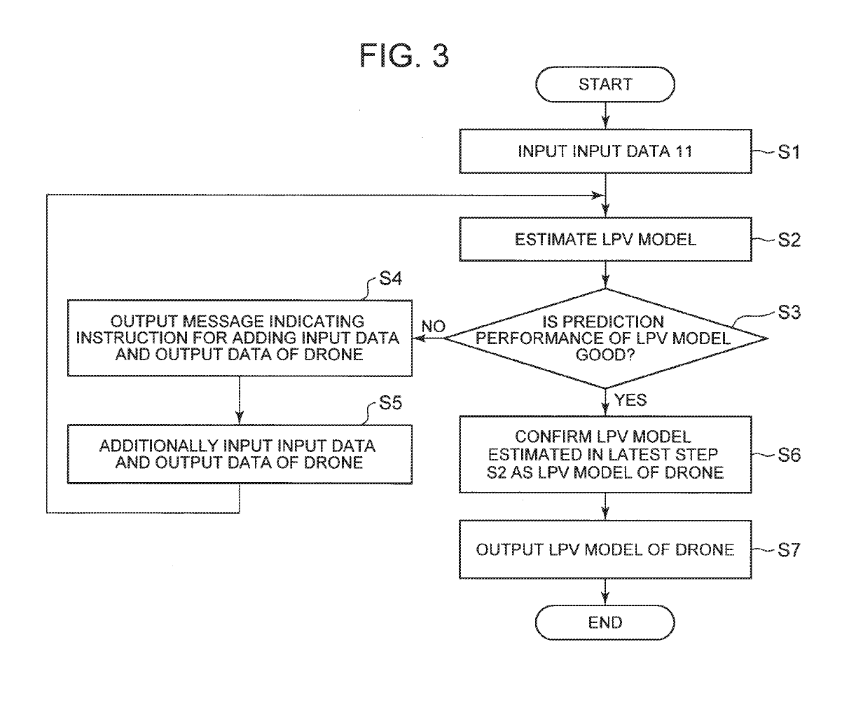

Next, a process flow of the present invention will be described. FIG. 3 is a flowchart illustrating an example of a process flow of the LPV model estimation system 1 of the present invention.

First, the input data 11 is input to the input unit 2 (a step S1).

Next, the LPV model estimation unit 3 estimates the LPV model of the drone represented by the expression (3) (a step S2). When proceeding from the step S1 to the step S2, the LPV model estimation unit 3 estimates the LPV model based on the input data and the output data of the drone collected under the conditions around each of the endpoints 61.

Details of a process flow of the LPV model estimation unit 3 in the step S2 will be described later.

After the step S2, the quality determination unit 4 determines, based on the LPV model estimated in the step S2 and the input data and the output data of the drone used for prediction performance evaluation of the LPV model, whether the prediction performance of the LPV model estimated on the output data of the drone is good (a step S3).

For example, it is assumed that the conditions corresponding to the points 62 to 65 (see FIG. 1) away from each of the endpoints 61 in the operating region 60 are selected as the conditions for the collection of the data used for prediction performance evaluation. Then, it is assumed that the drone operator collects the values of the input data to and the values of the output data from the drone at times k=1, 2, . . . , M under the respective conditions corresponding to the points 62 to 65, and the value of the input data and the value of the output data at each time are input to the input unit 2 in the step S1.

The quality determination unit 4 uses the values of the input data and the values of the output data at times k=1, 2, . . . , M-1 collected under the conditions corresponding to the point 62 and the LPV model to predict the values of the output data of the drone at times k=2, 3, . . . , M. At this time, the quality determination unit 4 adjusts the value of the explanatory variable φₖ of the scheduling parameter prediction model in the expression (3) to an appropriate value to obtain a predicted value of the drone under the conditions corresponding to the point 62.

Further, the output data at times k=2, 3, . . . , M collected under the conditions corresponding to the point 62 is a true value. The quality determination unit 4 calculates, for example, a root mean squared error (RMSE) between the predicted value and the true value. Then, the quality determination unit 4 determines whether the value of the RMSE is equal to or less than a threshold value.

Here, the description has been given of the data collected under the conditions corresponding to the point 62 as an example, but the quality determination unit 4 performs the same processing on pieces of data collected under conditions corresponding to the points 63, 64, and 65.

For example, when the value of the RMSE is equal to or less than the threshold value at all of the points 62 to 65, the quality determination unit 4 determines that the prediction performance of the LPV model estimated in the step S2 on the output data of the drone is good. When the value of the RMSE exceeds the threshold value at any of the points 62 to 65, the quality determination unit 4 determines that the prediction performance of the LPV model estimated in the step S2 on the output data of the drone is not good.

A criterion for determining whether the prediction performance is good is not limited to the above-described example. For example, the conditions for the collection of the data used for prediction performance evaluation may be conditions corresponding to one point. In that case, the quality determination unit 4 may determine whether the prediction performance is good based on whether the value of the RMSE at the one point is equal to or less than the threshold value.

When a determination is made that the prediction performance of the LPV model is not good (No in the step S3), the data addition instruction unit 5 outputs the message indicating an instruction for adding the input data and the output data of the drone collected under conditions corresponding to a point in the operating region 60 (a step S4). The way of determining the point in the operating region 60 may be optional. For example, the data addition instruction unit 5 may determine any point in the operating region 60. Alternatively, the data addition instruction unit 5 may determine any point around any of the points 62 to 65 corresponding to the conditions for the collection of the data used for prediction performance evaluation. The data addition instruction unit 5 outputs a message indicating an instruction for adding the input data and output data of the drone collected under conditions corresponding to the point. For example, it is assumed that the data addition instruction unit 5 determines a point at coordinates (2.5, 2.5). In this case, the data addition instruction unit 5 outputs a message indicating an instruction for adding the input data and the output data of the drone collected under conditions that the wind speed is 2.5 m/s and the load weight is 2.5 kg.

The user of the LPV model estimation system 1 informs the drone operator of contents of the message. In response to the message, the drone operator collects new input data and output data of the drone. For example, when the contents of the message in the above-described example are conveyed, the drone operator collects values of the input data and values of the output data at a plurality of consecutive times under the conditions that the wind speed is 2.5 m/s and the load weight is 2.5 kg. At this time, times k=1, 2, . . . , N may be assigned as the plurality of consecutive times. The drone operator may pass the newly collected values of the input data and values of the output data of the drone at times k=1, 2, . . . , N to the user of the LPV model estimation system 1.

Next, the newly collected values of the input data and values of the output data of the drone at times k=1, 2, . . . , N are added to the input unit 2 by the user of the LPV model estimation system 1 (a step S5).

Note that, in the above-described example, the description has been given of the case where a human (the drone operator) collects the data to be additionally input. The data to be additionally input may be collected by any system other than a human.

After the step S5, the LPV model estimation unit 3 estimates the LPV model of the drone represented by the expression (3) (the step S2). When proceeding from the step S5 to the step S2, the LPV model estimation unit 3 estimates the LPV model from not only the input data and the output data of the drone collected under the conditions around each of the endpoints 61, but also the input data and the output data of the drone additionally input in the step S5. Accordingly, when proceeding from the step S5 to the step S2, the LPV model estimation unit 3 re-estimates the LPV model.

After the step S2, the LPV model estimation system 1 repeats the processing of the step S3 and subsequent steps. The more times the processing of the steps S2, S3, S4, and S5 is repeated, the greater an amount of the input data and the output data of the drone used for LPV model estimation becomes in the step S2. Accordingly, the prediction performance of the LPV model on the output data of the drone will increase.

When determining that the prediction performance of the LPV model is good (Yes in the step S3), the quality determination unit 4 confirms an LPV model determined in the latest step S2 as the LPV model of the drone (a step S6).

Next, the LPV model output unit 6 outputs the LPV model confirmed as the LPV model of the drone (a step S7).

Next, a description will be given of details of the configuration and the process flow (the process flow of the step S2) of the LPV model estimation unit 3.

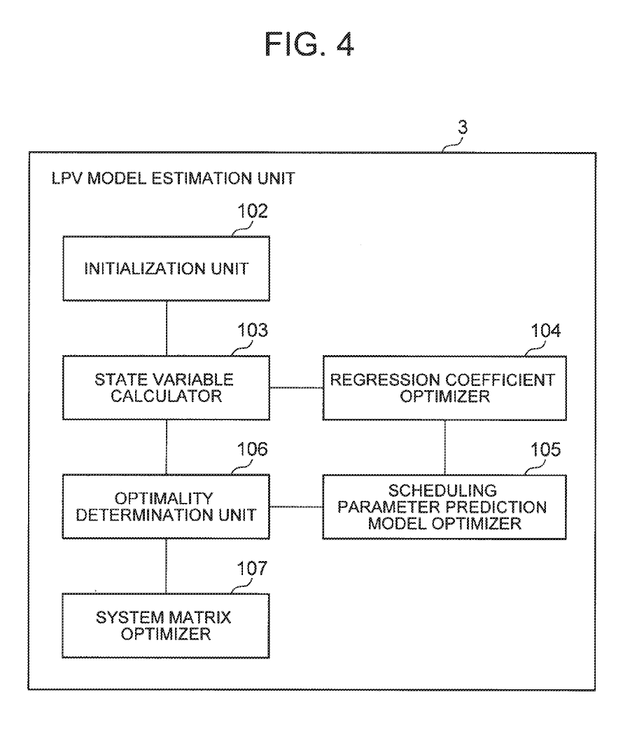

FIG. 4 is a block diagram illustrating an example of the configuration of the LPV model estimation unit 3. The LPV model estimation unit 3 includes an initialization unit 102, a state variable calculator 103, a regression coefficient optimizer 104, a scheduling parameter prediction model optimizer 105, an optimality determination unit 106, a system matrix optimizer 107.

The initialization unit 102 determines an initial value of the scheduling parameter μₖ⁽ⁱ⁾ of each local model at each time k=p, p+1, . . . , N. The initialization unit 102 determines the initial value of the scheduling parameter for each combination of i and k. As described above, the value of each scheduling parameter is equal to or greater than 0. Further, a sum of the values of the respective scheduling parameters of the local models at any given time is 1. Therefore, when a condition that the initial value of each scheduling parameter is equal to or greater than 0 and the sum of the initial values of the scheduling parameters of m local models at the same time is 1 is satisfied, the initialization unit 102 may determine the initial value of the scheduling parameter of each local model at each time by any method.

The state variable calculator 103 calculates, based on the value of the input data to and the value of the output data from the target system that have been input to the input unit 2 (see FIG. 2), and the value of the scheduling parameter of each local model, a value of a state variable xₖ at a past time.

When calculating the value of the state variable xₖ, the state variable calculator 103 performs the subspace identification on the LPV model. At this time, the state variable calculator 103 obtains an extended observability matrix from the input data and the output data at times k=1, 2, . . . , N, the number of local models, and the window parameter and calculates the value of the state variable xₖ based on the extended observability matrix. More specifically, the state variable calculator 103 creates a time series sample. Then, the state variable calculator 103 approximates, based on the assumption that the target system is stable, a correspondence relation between a time series sample at time k and a time series sample at time k+p by a linear regression model. At this time, the state variable calculator 103 uses the local model number m. The state variable calculator 103 obtains a regression coefficient in the linear regression model by the least squares method. The state variable calculator 103 obtains a product of the extended observability matrix and an extended reachability matrix using the regression coefficient, and applies singular value decomposition to the product to calculate the value of the state variable xₖ at the past time.

Note that pieces of data at first times k=1, . . . , p−1 of the N times are not allowed to constitute the time series sample. Therefore, the state variable calculator 103 obtains the value of the state variable xₖ at each of the times k=p, p+1, . . . , N obtained by excluding the times k=1, . . . , p−1 from the N times.

As will be described later, the scheduling parameter prediction model optimizer 105 derives the scheduling parameter prediction model and calculates the value of the scheduling parameter of each local model based on the scheduling parameter prediction model. When calculating first the value of the state variable xₖ, the state variable calculator 103 uses the initial value of the scheduling parameter determined by the initialization unit 102. In the second or later processing for calculating the value of the state variable xₖ, the state variable calculator 103 uses the value of the scheduling parameter calculated by the scheduling parameter prediction model optimizer 105 based on the scheduling parameter prediction model.

The regression coefficient optimizer 104 optimizes a regression coefficient W⁽ⁱ⁾ in the LPV model using the value of the scheduling parameter and the value of the state variable that have been calculated. The regression coefficient W⁽ⁱ⁾ in the LPV model is a combination of A⁽ⁱ⁾, B⁽ⁱ⁾, and C in the expression (3). Specifically, W⁽ⁱ⁾ is a coefficient calculated as W⁽ⁱ⁾:=[CA⁽ⁱ⁾, CB⁽ⁱ⁾]. As will be described later, A⁽ⁱ⁾, B⁽ⁱ⁾, K⁽ⁱ⁾, C, and D (see the expression (3)) are each called a system matrix. Accordingly, it can be said that the regression coefficient W⁽ⁱ⁾ is a coefficient represented by predetermined system matrices A⁽ⁱ⁾, B⁽ⁱ⁾, and C of the system matrices. Note that the regression coefficient optimizer 104 assumes that D in the expression (3) is a zero matrix. Further, K⁽ⁱ⁾ in the expression (3) relates to a regression error, and thus is not a component of the regression coefficient W⁽ⁱ⁾.

The regression coefficient optimizer 104 calculates the value of the regression coefficient W⁽ⁱ⁾ that causes the value of the evaluation function of LPV system identification to be a minimum value, with the value of the scheduling parameter and the value of the state variable that have been calculated set as fixed values. This value is an optimum value of the regression coefficient W⁽ⁱ⁾.

The above-described evaluation function is represented by the following expression (4).

$$\begin{matrix}[ Math . 4 ] & \\ {\sum }_{k = 0}^{N - 1} {‖ {y}_{k + 1} - {\sum }_{i = 1}^{m} {μ}_{k}^{( i )} {W}^{( i )} [ \begin{matrix}{x}_{k} \\ {u}_{k}\end{matrix} ] ‖}^{2} & ( 4 )\end{matrix}$$

That is, the regression coefficient optimizer 104 may solve the following expression (5) with the value of the scheduling parameter and the value of the state variable that have been calculated set as fixed values.

$$\begin{matrix}[ Math . 5 ] & \\ {μ}^{N ★} , {x}^{N ★} , {W}^{★} = {arg min}_{{μ}^{N} , {x}^{N} , W} {\sum }_{k = 0}^{N - 1} {‖ {y}_{k + 1} - {\sum }_{i = 1}^{m} {μ}_{k}^{( i )} {W}^{( i )} [ \begin{matrix}{x}_{k} \\ {u}_{k}\end{matrix} ] ‖}^{2} & ( 5 )\end{matrix}$$

Setting the value of the scheduling parameter and the value of the state variable that have been calculated as fixed values allows an objective function to be transformed to the following expression (6).

$$\begin{matrix}[ Math . 6 ] & \\ {arg min}_{W} {\sum }_{k = p + 1}^{N} {‖ {y}_{k + 1} - {W}_{{μ}_{k}} ⊗ [ \begin{matrix}{x}_{k} \\ {u}_{k}\end{matrix} ] ‖}^{2} & ( 6 )\end{matrix}$$

W in the expression (6) represents W⁽¹⁾, W⁽²⁾, . . . , W^{(m)}. The regression coefficient optimizer 104 calculates W by the least squares method using W as a regression coefficient and the others as explanatory variables in the second term in the norm shown in the expression (6) after the expression transformation.

The scheduling parameter prediction model optimizer 105 optimizes the scheduling parameter prediction model of each local model using the value of the state variable and the value of the regression coefficient W⁽ⁱ⁾ that have been calculated.

The scheduling parameter prediction model optimizer 105 calculates, with the value of the state variable and the value of the regression coefficient W⁽ⁱ⁾ that have been calculated set as fixed values, the value of the scheduling parameter that causes the value of the evaluation function of LPV system identification (see the expression (4)) to be the minimum value. However, the scheduling parameter prediction model optimizer 105 obtains the values of the scheduling parameter μₖ⁽ⁱ⁾ of each local model at times k=p, p+1, . . . , N.

Setting the value of the state variable and the value of the regression coefficient W⁽ⁱ⁾ that have been calculated as fixed values allows the expression (5) to be transformed to the following expression (7).

$$\begin{matrix}[ Math . 7 ] & \\ {μ}_{k}^{★} = {arg min}_{{μ}_{k}} \{ \frac{1}{2} {μ}_{k}^{T} ( 2 {Λ}_{k}^{T} {Λ}_{k} ) {μ}_{k} - 2 {y}_{k + 1}^{T} {Λ}_{k} {μ}_{k} \} & ( 7 )\end{matrix}$$

Note that T represents a transposed matrix.

Note that it is assumed that the following expression (8) is satisfied.

[Math. 8]

1ₘ^{T}μₖ=1, −μₖ≤0ₘ (8)

Further, λₖ⁽ⁱ⁾, Λₖ, 1ₘ, 0ₘ are represented by the following respective expressions.

$$\begin{matrix}[ Math . 9 ] & \\ {λ}_{k}^{( i )} \text{:} = {W}^{( i )} [ \begin{matrix}{x}_{k} \\ {u}_{k}\end{matrix} ] & \\ [ Math . 10 ] & \\ {Λ}_{k} \text{:} = [ {λ}_{k}^{( 1 )} , … , {λ}_{k}^{( m )} ] & \\ [ Math . 11 ] & \\ {1}_{m} \text{:} = {[ 1 , … , 1 ]}^{T} ∈ {m}^{} & \\ [ Math . 12 ] & \\ {0}_{m} \text{:} = {[ 0 , … , 0 ]}^{T} ∈ {m}^{} & \\ Further , & \\ [ Math . 13 ] & \\ {m}^{} & \end{matrix}$$

represents an m-dimensional vector.

The scheduling parameter prediction model optimizer 105 calculates the value of the scheduling parameter that causes the value of the evaluation function represented by the expression (4) to be the minimum value by solving a quadratic programming problem in the expression (7). This value is an optimum value of the scheduling parameter. As a result, the value of the scheduling parameter of each local model is obtained.

The scheduling parameter prediction model optimizer 105 derives a scheduling parameter prediction model for each local model based on the value of the scheduling parameter calculated as described above, the format of the scheduling parameter prediction model determined for each local model, and the value of the explanatory variable φ. The scheduling parameter prediction model optimizer 105 may derive the scheduling parameter prediction model through machine learning. This machine learning is mainly supervised learning. For such machine learning, for example, kernel linear regression or support vector machine may be adopted. Note that the format of the scheduling parameter prediction model determined for each local model and the value of the explanatory variable φ are input through the input unit 2 (see FIG. 2).

Furthermore, the scheduling parameter prediction model optimizer 105 calculates the value of the scheduling parameter based on the scheduling parameter prediction model thus derived. The scheduling parameter prediction model optimizer 105 may calculate the value of the scheduling parameter by substituting the value of the explanatory variable φ into the scheduling parameter prediction model derived.

The scheduling parameter needs to satisfy a condition for corresponding to a convex combination coefficient. That is, the condition that the value of each scheduling parameter is equal to or greater than 0 and the sum of the values of the scheduling parameters of the m local models at the same time is 1 needs to be satisfied. In order to satisfy such a condition, the scheduling parameter prediction model optimizer 105 adjusts the value of the scheduling parameter by performing the following processing.

The scheduling parameter prediction model optimizer 105 adjusts the value of the scheduling parameter by solving a quadratic programming problem in the following expression (9).

$$\begin{matrix}[ Math . 14 ] & \\ {\hat{μ}}_{k}^{★} = {arg min}_{\hat{μ}} {‖ {\hat{μ}}_{k} - {\tilde{μ}}_{k} ‖}^{2} = {arg min}_{\hat{μ}} ( {\hat{μ}}_{k}^{T} {\hat{μ}}_{k} - 2 {\tilde{μ}}_{k}^{T} {\hat{μ}}_{k} ) & ( 9 )\end{matrix}$$

Note that it is assumed that the following expression (10) is satisfied.

[Math. 15]

1ₘ^{T}\tilde{μ}ₖ=1, −\tilde{μ}ₖ≤0ₘ (10)

Here, μ with a tilde is represented by the following expression.

[Math. 16]

\tilde{μ}ₖ:=W*_{g}ϕₖ

Further, μ with a caret represents the scheduling parameter calculated based on the scheduling parameter prediction model.

The optimality determination unit 106 determines whether the value of the evaluation function represented by the expression (4) has converged.

The state variable calculator 103, the regression coefficient optimizer 104, and the scheduling parameter prediction model optimizer 105 sequentially repeat the above-described processing until a determination is made that the value of the evaluation function has converged.

When the determination is made that the value of the evaluation function has converged, the system matrix optimizer 107 performs regression calculation using the value of the state variable (the optimum value of the state variable) and the value of the scheduling parameter calculated based on the scheduling parameter prediction model that have been obtained at the time to optimize each system matrix of the LPV model. Here, each system matrix corresponds to A⁽ⁱ⁾, B⁽ⁱ⁾, K⁽ⁱ⁾, C, or D (see the expression (3)) in each local model. That is, A⁽ⁱ⁾, B⁽ⁱ⁾, K⁽ⁱ⁾, C, and D each correspond to the system matrix.

The system matrix optimizer 107 may calculate each system matrix of A⁽ⁱ⁾, B⁽ⁱ⁾, K⁽ⁱ⁾, C, and D by the least squares method from yₖ, uₖ, and xₖ at each time. Each system matrix thus obtained corresponds to an optimized system matrix.

The system matrix optimizer 107 determines an LPV model represented by each system matrix of A⁽ⁱ⁾, B⁽ⁱ⁾, K⁽ⁱ⁾, C, and D thus calculated and the scheduling parameter prediction model gᵢ (φₖ) obtained at the time when the determination is made that the value of the evaluation function has converged. This LPV model is a result of estimating the LPV model of the target system. That is, it can be said that the system matrix optimizer 107 estimates the LPV model of the target system. Further, it can be said that the system matrix optimizer 107 represents the scheduling parameter as the scheduling parameter prediction model gᵢ (φₖ) in the LPV model.

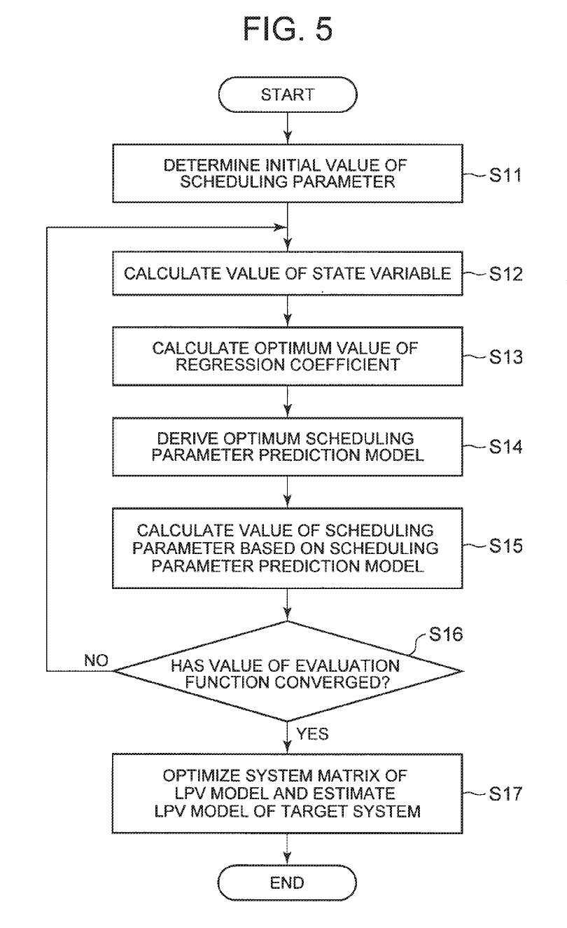

Next, the process flow of the LPV model estimation unit 3 (that is, the process flow of the step S2) will be described. FIG. 5 is a flowchart illustrating an example of the process flow of the step S2 executed by the LPV model estimation unit 3. Details of the operation of each component of the LPV model estimation unit 3 have been already described; thus, no detailed description of the operation will be given in the following description.

The initialization unit 102 determines the initial value of the scheduling parameter μₖ⁽ⁱ⁾ of each local model (a step S11). The local model number m is included in the input data 11. In the step S11, the initialization unit 102 determines the initial value of the scheduling parameter μₖ⁽ⁱ⁾ of each local model such that the condition that the initial value of each scheduling parameter is equal to or greater than 0 and the sum of the initial values of the scheduling parameters of the m local models at the same time is 1 is satisfied. When the above-described condition is satisfied, the initialization unit 102 may sequentially determine the initial value of the scheduling parameter μₖ⁽ⁱ⁾ at random.

Next, the state variable calculator 103 calculates the value of the state variable xₖ at the past time based on the value of the input data to the target system and the value of the output data from the target system that have been input to the input unit 2 (see FIG. 2), and the value of the scheduling parameter of each local model (a step S12). When proceeding to the step S12 for the first time, the state variable calculator 103 uses the initial value of the scheduling parameter determined in the step S11.

Next, the regression coefficient optimizer 104 calculates the optimum value of the regression coefficient W⁽ⁱ⁾ in the LPV model using the value of the scheduling parameter and the value of the state variable that have been calculated (a step S13). When proceeding to step S13 first, the regression coefficient optimizer 104 uses the initial value of the scheduling parameter determined in the step S11. In the step S13, the regression coefficient optimizer 104 calculates, with the value of the scheduling parameter and the value of the state variable that have been calculated set as fixed values, the value of the regression coefficient W⁽ⁱ⁾ that causes the value of the evaluation function represented by the expression (4) to be the minimum value.

Next, the scheduling parameter prediction model optimizer 105 derives an optimum scheduling parameter prediction model of each local model using the value of the state variable and the value of the regression coefficient W⁽ⁱ⁾ that have been calculated (a step S14). In the step S14, the scheduling parameter prediction model optimizer 105 calculates, with the value of the state variable and the value of the regression coefficient W⁽ⁱ⁾ that have been calculated set as fixed values, the value of the scheduling parameter that causes the value of the evaluation function represented by the expression (4) to be the minimum value. Furthermore, the scheduling parameter prediction model optimizer 105 derives, through machine learning, the scheduling parameter prediction model for each local model based on the value of the scheduling parameter, the format of the scheduling parameter prediction model determined for each local model, and the value of the explanatory variable φ.

Next, the scheduling parameter prediction model optimizer 105 calculates the value of the scheduling parameter based on the scheduling parameter prediction model thus derived (a step S15). In the step S15, after calculating the value of the scheduling parameter, the scheduling parameter prediction model optimizer 105 adjusts the value of the scheduling parameter thus calculated such that the condition that the value of each scheduling parameter is equal to or greater than 0 and the sum of the values of the scheduling parameters of the m local models at the same time is 1 is satisfied.

Next, the optimality determination unit 106 determines whether the value of the evaluation function represented by the expression (4) has converged (a step S16). As described above, in the step S14, the scheduling parameter prediction model optimizer 105 calculates, with the value of the state variable and the value of the regression coefficient W⁽ⁱ⁾ that have been calculated set as fixed values, the value of the scheduling parameter that causes the value of the evaluation function represented by the expression (4) to be the minimum value. For example, when an absolute value of a difference between the minimum value of the evaluation function in the latest step S14 and the minimum value of the evaluation function in the previous step S14 is equal to or less than a predetermined threshold value, the optimality determination unit 106 may determine that the value of the evaluation function has converged, and when the absolute value of the difference exceeds the predetermined threshold value, the optimality determination unit 106 may determine that the value of the evaluation function has not converged.

Alternatively, after calculating a Frobenius norm of a difference between the regression coefficient W⁽ⁱ⁾ calculated in the latest step S13 and the regression coefficient W⁽ⁱ⁾ calculated in the previous step S13, when the Frobenius norm is equal to or less than the predetermined threshold value, the optimality determination unit 106 may determine that the value of the evaluation function has converged, and when the Frobenius norm exceeds he predetermined threshold value, the optimality determination unit 106 may determine that the value of the evaluation function has not converged. Note that it can be said that the Frobenius norm of the difference between the regression coefficients W⁽ⁱ⁾ represents proximity between the regression coefficients W⁽ⁱ⁾.

When a determination is made that the value of the evaluation function has not converged (No in the step S16), the LPV model estimation system 1 repeats the processing of the step S12 and subsequent steps. In the second or later processing of the step S12, the state variable calculator 103 uses the value of the scheduling parameter calculated in the latest step S15. Similarly, in the second or later processing of the step S13, the regression coefficient optimizer 104 uses the value of the scheduling parameter calculated in the latest step S15.

When a determination is made that the value of the evaluation function has converged (Yes in the step S16), the system matrix optimizer 107 optimizes each system matrix of the LPV model (A⁽ⁱ⁾, B⁽ⁱ⁾, K⁽ⁱ⁾, C, or D in the expression (3)) using the value of the state variable obtained in the latest step S12 and the value of the scheduling parameter obtained in the latest step S15 (the value adjusted such that the above-described condition is satisfied). The system matrix optimizer 107 determines the LPV model represented by the system matrices A⁽ⁱ⁾, B⁽ⁱ⁾, K⁽ⁱ⁾, C, and D, and the scheduling parameter prediction model obtained in the latest step S14 (a step S17). This LPV model is a result of estimating the LPV model of the target system.

The LPV model estimation unit 3 (the LPV model estimation unit 3 including the initialization unit 102, the state variable calculator 103, the regression coefficient optimizer 104, the scheduling parameter prediction model optimizer 105, the optimality determination unit 106, and the system matrix optimizer 107), the quality determination unit 4, the data addition instruction unit 5, and the LPV model output unit 6 are implemented by, for example, a CPU of a computer operating in accordance with a linear parameter varying model estimation program. In this configuration, for example, the CPU may read the linear parameter varying model estimation program from a program recording medium such as a program storage device (not illustrated in FIG. 2) of the computer and operate as the LPV model estimation unit 3, the quality determination unit 4, the data addition instruction unit 5, and the LPV model output unit 6 in accordance with the program. Further, the LPV model estimation unit 3, the quality determination unit 4, the data addition instruction unit 5, and the LPV model output unit 6 may be each implemented by separate hardware. Furthermore, in the LPV model estimation unit 3, the initialization unit 102, the state variable calculator 103, the regression coefficient optimizer 104, the scheduling parameter prediction model optimizer 105, the optimality determination unit 106, and the system matrix optimizer 107 may be each implemented by separate hardware.

Further, the LPV model estimation system 1 may be constituted of two or more physically separated devices that are connected by wire or radio.

According to the present exemplary embodiment, the input data and the output data of the drone collected under the conditions around each of the endpoints 61 are input to the input unit 2, and the LPV model estimation unit 3 calculates the LPV model of the drone based on the input data and the output data (the step S2, see FIG. 3). Then, the quality determination unit 4 determines whether the prediction performance of the LPV model on the output data of the drone is good (the step S3, see FIG. 3). When the quality determination unit 4 determines that the prediction performance is not good, the data addition instruction unit 5 outputs the message indicating an instruction for adding the input data and the output data of the drone collected under the conditions corresponding to a point in the operating region 60 (the step S4, see FIG. 3). When the input data and the output data of the drone newly collected are additionally input in response to this message (the step S5, see FIG. 3), the LPV model estimation unit 3 re-estimates the LPV model based on the input data and output data additionally input and the input data and output data of the drone collected under the conditions around each of the endpoints 61. The LPV model estimation system 1 repeats the processing of the steps S2, S3, S4, and S5 until a determination is made that the prediction performance is good. When determining that the prediction performance is good, the quality determination unit 4 designates the LPV model most recently estimated as the LPV model of the drone.

This only requires collection of input data and output data necessary for determining that the prediction performance is good. Thus, the present invention allows the LPV model exhibiting good prediction performance to be estimated with a less collection amount of data used for estimating the LPV model.

Further, in the above, the description has been given, as an example, of the plurality of endpoints 61 and the operating region 60 having the endpoints 61 determined based on the specification of the target system. It can be said that the operating region 60 determined in accordance with the specification corresponds to an operating region set most largely. Here, it can be said that the following relation is satisfied between a size of the operating region and the prediction performance of the LPV model. That is, the larger the operating region is, the larger a convex hull of the plurality of local models becomes, which allows the output data of the target system under various conditions to be predicted from the LPV model. On the other hand, the prediction performance of the LPV model on output data is relatively lower than the prediction performance when the operating region is smaller. Further, the smaller the operating region is, the smaller the convex hull of the plurality of local models becomes, which narrows a range of conditions under which the output data can be predicted from the LPV model. For example, it is not possible to predict output data under conditions corresponding to a point outside the operating region. On the other hand, under the conditions in the operating region, the prediction performance of the LPV model on output data is relatively higher than the prediction performance when the operating region is larger.

Therefore, it is assumed that, after the LPV model estimation system 1 of the above-described exemplary embodiment outputs the LPV model of the drone in the step S7, it is revealed that defining an operating region having a narrower range is appropriate. In this case, the LPV model estimation system 1 performs the same operation as the operation described above based on the operating region, thereby allowing an LPV model exhibiting higher prediction performance to be obtained.

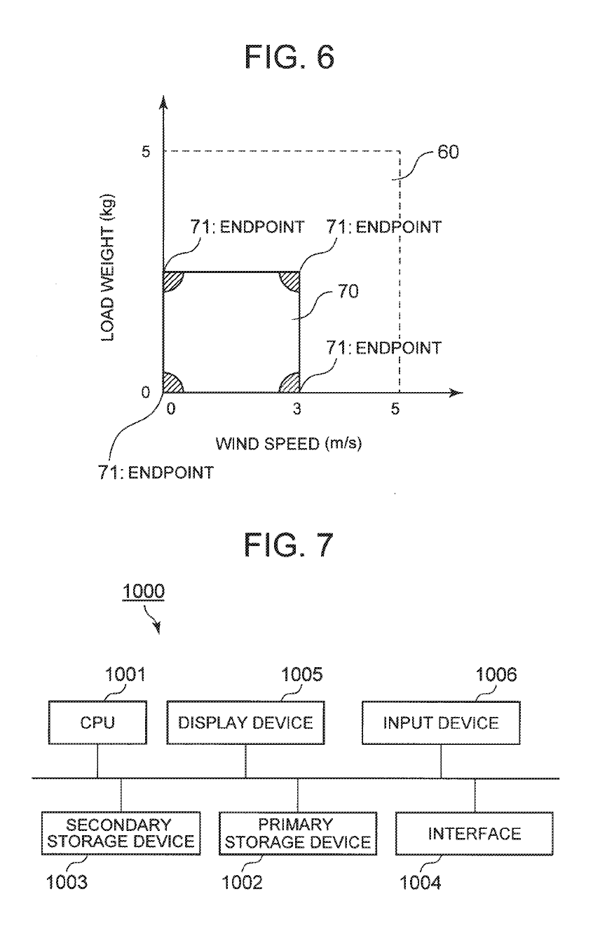

For example, it is assumed that the LPV model estimation system 1 outputs the LPV model of the drone in the step S7. Then, it is assumed that it is revealed that the drone operator does not use the drone under the conditions around the upper limit value specified in the specification as the drone operator operates the drone. For example, it is assumed that it is revealed that the drone is not used under an environment where the wind speed is equal to or greater than 3 m/s, or the drone is not used with a load having 2.5 kg or more. In this case, as illustrated in FIG. 6, it is possible to newly determine an operating region 70 narrower than the operating region 60 determined in accordance with the specification and endpoints 71 of the operating region 70.

In this case, the drone operator may collect the input data and the output data of the drone under conditions around each of the new endpoints 71 and collect the input data and the output data of the drone used for prediction performance evaluation in accordance with the new operating region 70. When new input data 11 including these pieces of data is input, the LPV model estimation system 1 performs the same operation as the operation described in the above-described exemplary embodiment using the input data 11. As a result, a new LPV model based on the operating region 70 is obtained.

In the LPV model based on the operating region 70, the range of conditions under which the output data of the drone can be predicted is narrower than the LPV model based on the operating region 60. For example, the LPV model based on the operating region 70 is unable to predict the output data of the drone under the conditions that the wind speed is “4 m/s” and the load weight is “4.5 kg”. However, higher prediction performance can be achieved within the range of conditions under which the output data of the drone can be predicted. Further, the new endpoints 71 are determined based on the upper limit value and the lower limit value applied when the drone is actually used; thus, it can be said that the prediction is originally unnecessary for the output data under the conditions corresponding to points outside the range of the operating region 70.

As described above, defining a narrower operating region and endpoints of the operating region based on the upper limit value and lower limit value of the conditions found through the actual use of the drone allows an LPV model exhibiting higher prediction performance to be obtained.

In the above-described exemplary embodiment, the description has been given, as an example, of the case where the target system is a drone, but the target system is not limited to the drone.

For example, the present invention may be applied to an automobile that serves as the target system. In this case, for example, the operating region may be determined with “a road surface temperature” and “a weight of a load placed on the automobile” set as conditions. Further, examples of input data of the automobile include a steering angle of the automobile and a rotation speed of each wheel of the automobile. Further, examples of output data of the automobile include an attitude and position of the automobile.

Further, for example, the present invention may be applied to a robot arm that serves as the target system. In this case, the operating region may be determined with “a weight of a load held by the robot arm” set as a condition. In a case where one condition “a weight of a load held by the robot arm” is determined, the operating region is represented by a line segment. Further, examples of input data of the robot arm include a rotation angle of a rotor of the robot arm. Further, examples of output data of the robot arm include an orientation of the robot arm.

Further, the target system is not limited to a physical system. For example, the present invention may be applied to a shop for selling products that serves as the target system. In this case, the operating region may be determined with “brightness inside the shop” and “a room temperature inside the shop” set as conditions. Further, examples of input data in this case include the number of displayed products. Further, examples of output data in this case include the number of sold products. In this case, the LPV model obtained according to the present invention allows the number of discarded products to be controlled.

FIG. 7 is a schematic block diagram illustrating an example of a configuration of the computer according to the exemplary embodiment of the present invention. A computer 1000 includes a CPU 1001, a primary storage device 1002, a secondary storage device 1003, an interface 1004, a display device 1005, and an input device 1006. In the example illustrated in FIG. 7, the input device 1006 corresponds to the input unit 2 (see FIG. 2). However, the computer 1000 only needs to include the input unit 2 that supports an input mode of the data 11.

The LPV model estimation system 1 according to the exemplary embodiment of the present invention is installed in the computer 1000. The operation of the LPV model estimation system 1 is stored in the secondary storage device 1003 in the form of a program (the linear parameter varying model estimation program). The CPU 1001 reads the program from the secondary storage device 1003, loads the program onto the primary storage device 1002, and executes the above-described processing in accordance with the program.

The secondary storage device 1003 is an example of a non-transitory tangible medium. Other examples of such a non-transitory tangible medium include a magnetic disk, a magneto-optical disk, a CD-ROM, a DVD-ROM, a semiconductor memory, and the like connected via the interface 1004. Further, when this program is delivered to the computer 1000 over a communication line, the computer 1000 that has received the program may load the program onto the primary storage device 1002 and execute the above-described processing.

Further, the program may be used for implementing part of the above-described processing. Furthermore, the program may be a differential program that implements the above-described processing in combination with another program already stored in the secondary storage device 1003.

Further, some or all of the components of each device are implemented by general-purpose or dedicated circuitry, a processor, and the like, or a combination thereof. These elements may be formed on a single chip or may be formed on a plurality of chips connected via a bus. Some or all of the components of each device may be implemented by a combination of the above-described circuitry and the like and the program.

In a case where some or all of the components of each device are implemented by a plurality of information processing devices, or the circuitry and the like, the plurality of information processing devices, or the circuitry and the like may be arranged in a concentrated manner or in a distributed manner. For example, the information processing devices, or the circuitry and the like may be implemented in a form in which elements such as a client and server system and a cloud computing system are connected over a communication network.

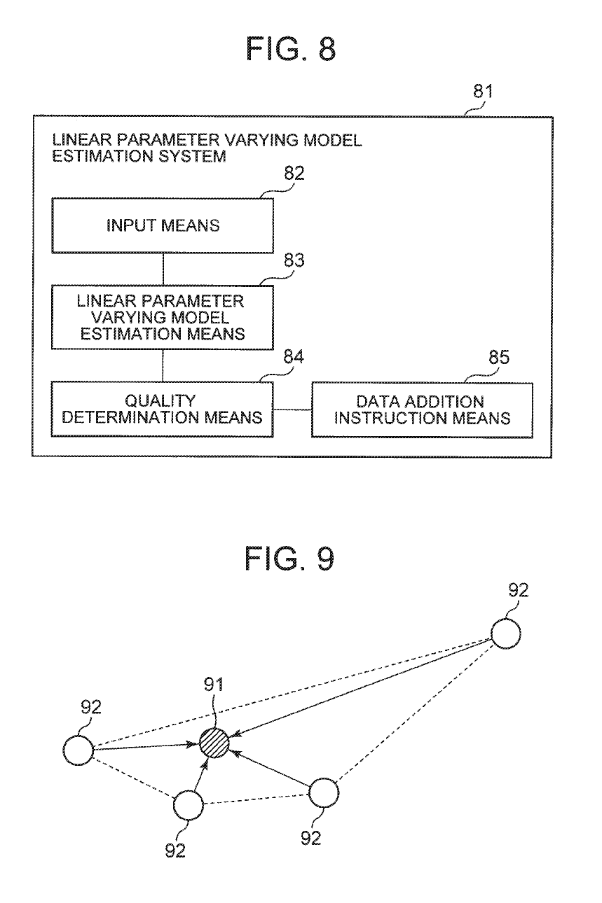

Next, the outline of the present invention will be described. FIG. 8 is a block diagram illustrating the outline of the linear parameter varying model estimation system of the present invention. The linear parameter varying model estimation system 81 includes an input means 82, a linear parameter varying model estimation means 83, a quality determination means 84, and a data addition instruction means 85.

To the input means 82 (for example, the input unit 2), information on an operating region indicating a range of possible values of a condition under which a target system to be modeled by a linear parameter varying model operates, input data and output data of the target system collected under conditions around each endpoint of the operating region, and input data and output data of the target system used for prediction performance evaluation of the linear parameter varying model are input.

The linear parameter varying model estimation means 83 (for example, the LPV model estimation unit 3) estimates the linear parameter varying model of the target system based on the input data and output data of the target system collected under the conditions around each endpoint.

The quality determination means 84 (for example, the quality determination unit 4) determines whether prediction performance of the linear parameter varying model on output data based on the linear parameter varying model and the input data and the output data of the target system used for prediction performance evaluation is good, and, when determining that the prediction performance is good, designates the linear parameter varying model as the linear parameter varying model of the target system.

When a determination is made that the prediction performance is not good, the data addition instruction means 85 (for example, the data addition instruction unit 5) outputs a message indicating an instruction for adding the input data and output data of the target system collected under conditions corresponding to a point in the operating region.

When the input data and output data of the target system are additionally input to the input means 82 in response to the message, the linear parameter varying model estimation means 83 estimates the linear parameter varying model of the target system based on the input data and output data and the input data and output data of the target system collected under the conditions around each endpoint.

Such a configuration allows a linear parameter varying model exhibiting good prediction performance to be estimated with a less collection amount of data used for estimating the linear parameter varying model.

Further, it is preferable that the linear parameter varying model estimation means 83 represent, in the linear parameter varying model, a scheduling parameter as a scheduling parameter prediction model corresponding to a function of a scheduling parameter with an explanatory variable.

Further, a configuration may be employed in which the linear parameter varying model estimation means 83 includes: an initial value determination means (for example, the initialization unit 102) that determines an initial value of a scheduling parameter of the target system; a state variable calculation means (for example, the state variable calculator 103) that calculates a value of a state variable based on values of the input data, the output data, and the scheduling parameter of the target system; a regression coefficient calculation means (for example, the regression coefficient optimizer 104) that calculates a value of a regression coefficient that causes a value of a predetermined evaluation function (for example, the evaluation function represented by the expression (4)) to be a minimum value with the value of the scheduling parameter and the value of the state variable set as fixed values; a scheduling parameter prediction model derivation means (for example, the scheduling parameter prediction model optimizer 105) that calculates a value of the scheduling parameter that causes the value of the predetermined evaluation function to be the minimum value with the value of the state variable and the value of the regression coefficient set as fixed values, derives a scheduling parameter prediction model corresponding to the function of a scheduling parameter using an explanatory variable based on the value of the scheduling parameter and a value of an explanatory variable that is predetermined, and calculates a value of the scheduling parameter based on the scheduling parameter prediction model; a convergence determination means (for example, the optimality determination unit 106) that determines whether the value of the evaluation function has converged, the state variable calculation means, the regression coefficient calculation means, and the scheduling parameter prediction model derivation means being configured to repeat, until a determination is made that the value of the evaluation function has converged, processing where the state variable calculation means calculates the value of the state variable, the regression coefficient calculation means calculates the value of the regression coefficient, and the scheduling parameter prediction model derivation means derives the scheduling parameter prediction model and calculates the value of the scheduling parameter based on the scheduling parameter prediction model; and a model estimation means (for example, the system matrix optimizer 107) that estimates the linear parameter varying model of the target system based on a value of the state variable at a time when the determination is made that the value of the evaluation function has converged and the value of the scheduling parameter, the model estimation means being configured to represent, in the linear parameter varying model, the scheduling parameter as the scheduling parameter prediction model.

Although the invention of the present application has been described with reference to the exemplary embodiment, the invention of the present application is not limited to the exemplary embodiment. Various changes that can be understood by those skilled in the art can be made to the configuration and details of the invention of the present application within the scope of the invention of the present application.

This application claims priority based on Japanese Patent Application No. 2016-135115 filed on Jul. 7, 2016, the disclosure of which is incorporated herein in its entirety.

### INDUSTRIAL APPLICABILITY

The present invention is suitably applied to an LPV model estimation system that estimates an LPV model of a system.

### REFERENCE SIGNS LIST

1 Linear parameter varying model estimation system (LPV model estimation system)
2 Input unit
3 LPV model estimation unit
4 Quality determination unit
5 Data addition instruction unit
6 LPV model output unit
102 Initialization unit
103 State variable calculator
104 Regression coefficient optimizer
105 Scheduling parameter prediction model optimizer
106 Optimality determination unit
107 System matrix optimizer

What is claimed is:

1. A linear parameter varying model estimation system comprising:
an input unit that receives information on an operating region indicating a range of possible values of a condition under which a target system to be modeled by a linear parameter varying model operates, input data and output data of the target system collected under a condition around each endpoint of the operating region, and input data and output data of the target system used for prediction performance evaluation of the linear parameter varying model;
a linear parameter varying model estimation unit that estimates the linear parameter varying model of the target system based on the input data and the output data of the target system collected under the condition around each endpoint;
a quality determination unit that determines whether prediction performance of the linear parameter varying model on output data is good based on the linear parameter varying model and the input data and the output data of the target system used for prediction performance evaluation, and designates, when determining that the prediction performance is good, the linear parameter varying model as the linear parameter varying model of the target system; and
a data addition instruction unit that outputs a message indicating an instruction for adding input data and output data of the target system collected under a condition corresponding to a point in the operating region when a determination is made that the prediction performance is not good,
wherein the linear parameter varying model estimation unit
estimates, when the input data and the output data of the target system are additionally input to the input unit in response to the message, the linear parameter varying model of the target system based on the input data and the output data, and the input data and the output data of the target system collected under the condition around each endpoint.

2. The linear parameter varying model estimation system according to claim 1,
wherein the linear parameter varying model estimation unit
represents, in the linear parameter varying model, a scheduling parameter as a scheduling parameter prediction model corresponding to a function of a scheduling parameter using an explanatory variable.

3. The linear parameter varying model estimation system according to claim 1,
wherein the linear parameter varying model estimation unit includes:
an initial value determination unit that determines an initial value of a scheduling parameter of the target system;
a state variable calculation unit that calculates a value of a state variable based on values of the input data, the output data, and the scheduling parameter of the target system;
a regression coefficient calculation unit that calculates a value of a regression coefficient that causes a value of a predetermined evaluation function to be a minimum value with the value of the scheduling parameter and the value of the state variable set as fixed values;
a scheduling parameter prediction model derivation unit that calculates a value of the scheduling parameter that causes the value of the predetermined evaluation function to be the minimum value with the value of the state variable and the value of the regression coefficient set as fixed values, derives a scheduling parameter prediction model corresponding to the function of a scheduling parameter using an explanatory variable based on the value of the scheduling parameter and a value of an explanatory variable that is predetermined, and calculates a value of the scheduling parameter based on the scheduling parameter prediction model;
a convergence determination unit that determines whether the value of the evaluation function has converged,
wherein the state variable calculation unit, the regression coefficient calculation unit, and the scheduling parameter prediction model derivation unit repeat, until a determination is made that the value of the evaluation function has converged, processing where the state variable calculation unit calculates the value of the state variable, the regression coefficient calculation unit calculates the value of the regression coefficient, and the scheduling parameter prediction model derivation unit derives the scheduling parameter prediction model and calculates the value of the scheduling parameter based on the scheduling parameter prediction model; and
a model estimation unit that estimates the linear parameter varying model of the target system based on a value of the state variable at a time when the determination is made that the value of the evaluation function has converged and the value of the scheduling parameter,
wherein the model estimation unit represents, in the linear parameter varying model, the scheduling parameter as the scheduling parameter prediction model.

4. A linear parameter varying model estimation method comprising:
receiving information on an operating region indicating a range of possible values of a condition under which a target system to be modeled by a linear parameter varying model operates, input data and output data of the target system collected under a condition around each endpoint of the operating region, and input data and output data of the target system used for prediction performance evaluation of the linear parameter varying model;
estimating the linear parameter varying model of the target system based on the input data and the output data of the target system collected under the condition around each endpoint;
determining whether prediction performance of the linear parameter varying model on output data is good based on the linear parameter varying model and the input data and the output data of the target system used for prediction performance evaluation and designating, when determining that the prediction performance is good, the linear parameter varying model as the linear parameter varying model of the target system;
outputting, when determining that the prediction performance is not good, a message indicating an instruction for adding input data and output data of the target system collected under a condition corresponding to a point in the operating region; and
estimating, when the input data and the output data of the target system are additionally input in response to the message, the linear parameter varying model of the target system based on the input data and the output data, and the input data and the output data of the target system collected under the condition around each endpoint.

5. The linear parameter varying model estimation method according to claim 4,
wherein in the linear parameter varying model, a scheduling parameter is represented as a scheduling parameter prediction model corresponding to a function of a scheduling parameter using an explanatory variable.

6. The linear parameter varying model estimation method according to claim 4, comprising:
when the linear parameter varying model of the target system is estimated,
determining an initial value of a scheduling parameter of the target system;
calculating a value of a state variable based on values of the input data, the output data, and the scheduling parameter of the target system;
calculating a value of a regression coefficient that causes a value of a predetermined evaluation function to be a minimum value with the value of the scheduling parameter and the value of the state variable set as fixed values;
calculating a value of the scheduling parameter that causes the value of the predetermined evaluation function to be the minimum value with the value of the state variable and the value of the regression coefficient set as fixed values, deriving a scheduling parameter prediction model corresponding to the function of a scheduling parameter using an explanatory variable based on the value of the scheduling parameter and a value of an explanatory variable that is predetermined, and calculating a value of the scheduling parameter based on the scheduling parameter prediction model;
determining whether the value of the evaluation function has converged;
repeating, until a determination is made that the value of the evaluation function has converged, processing where the value of the state variable is calculated, the value of the regression coefficient is calculated, the scheduling parameter prediction model is derived, and the value of the scheduling parameter is calculated based on the scheduling parameter prediction model; and
estimating the linear parameter varying model of the target system based on a value of the state variable at a time when the determination is made that the value of the evaluation function has converged and the value of the scheduling parameter;
wherein the scheduling parameter is represented, in the linear parameter varying model, as the scheduling parameter prediction model.

7. A non-transitory computer-readable recording medium in which a linear parameter varying model estimation program is recorded,
the linear parameter varying model estimation program installed in a computer, the computer including an input unit that receives information on an operating region indicating a range of possible values of a condition under which a target system to be modeled by a linear parameter varying model operates, input data and output data of the target system collected under a condition around each endpoint of the operating region, and input data and output data of the target system used for prediction performance evaluation of the linear parameter varying model, the program causing the computer to execute:
linear parameter varying model estimation processing that estimates the linear parameter varying model of the target system based on the input data and the output data of the target system collected under the condition around each endpoint;
quality determination processing that determines whether prediction performance of the linear parameter varying model on output data is good based on the linear parameter varying model and the input data and the output data of the target system used for prediction performance evaluation, and designates, when determining that the prediction performance is good, the linear parameter varying model as the linear parameter varying model of the target system; and
data addition instruction processing that outputs, when a determination is made that the prediction performance is not good, a message indicating an instruction for adding input data and output data of the target system collected under a condition corresponding to a point in the operating region,
wherein the linear parameter varying model estimation processing estimates, when the input data and the output data of the target system are additionally input to the input unit in response to the message, the linear parameter varying model of the target system based on the input data and the output data, and the input data and the output data of the target system collected under the condition around each endpoint.

8. The non-transitory computer-readable recording medium in which the linear parameter varying model estimation program is recorded, according to claim 7,
the linear parameter varying model estimation program causing the computer to represent,
in the linear parameter varying model estimation processing,
a scheduling parameter as a scheduling parameter prediction model corresponding to a function of a scheduling parameter using an explanatory variable in the linear parameter varying model.

9. The non-transitory computer-readable recording medium in which the linear parameter varying model estimation program is recorded, according to claim 7,
the linear parameter varying model estimation program causing the computer to execute:
in the linear parameter varying model estimation processing,
initial value determination processing that determines an initial value of a scheduling parameter of the target system;
state variable calculation processing that calculates a value of a state variable based on values of the input data, the output data, and the scheduling parameter of the target system;
regression coefficient calculation processing that calculates a value of a regression coefficient that causes a value of a predetermined evaluation function to be a minimum value with the value of the scheduling parameter and the value of the state variable set as fixed values;
scheduling parameter prediction model derivation processing that calculates a value of the scheduling parameter that causes the value of the predetermined evaluation function to be the minimum value with the value of the state variable and the value of the regression coefficient set as fixed values, derives a scheduling parameter prediction model corresponding to the function of a scheduling parameter using an explanatory variable based on the value of the scheduling parameter and a value of an explanatory variable that is predetermined, and calculates a value of the scheduling parameter based on the scheduling parameter prediction model;
conversion determination processing that determines whether the value of the evaluation function has converged,
wherein, until a determination is made that the value of the evaluation function has converged, the state variable calculation processing, the regression coefficient calculation processing, and the scheduling parameter prediction model derivation processing are repeated; and
model estimation processing that estimates the linear parameter varying model of the target system based on a value of the state variable at a time when the determination is made that the value of the evaluation function has converged and the value of the scheduling parameter,
wherein in the model estimation processing, the scheduling parameter is represented, in the linear parameter varying model, as the scheduling parameter prediction model.
